(19) United States
(12) Patent Application Publication
(10) Pub. No.: US 2010/0219709 A1
(43) Pub. Date: Sep. 2, 2010

(54) CIRCULAR SELF-POWERED MAGNETIC GENERATOR

(76) Inventor: Puthalath Koroth Raghuprasad, Odessa, TX (US)

Correspondence Address: DAVID L. KING, SR., 5131 N.E. COUNTY ROAD 340, HIGH SPRINGS, FL, 32643, US

(21) Appl. No.: 12/778,500

(22) Filed: May 12, 2010

Related U.S. Application Data
(63) Continuation-in-part of application No. 11/945,473, filed on Nov. 27, 2007.
Application No. 11/945,473 is a continuation-in-part of application No. PCT/US08/83951, filed on Nov. 19, 2008.

(51) Int. Cl. H02K 21/14; H02K 53/00

(52) U.S. Cl. 310/156.01; 415/916

(57) ABSTRACT

An improved power generation apparatus 100 has one or more moving permanent magnets 10, the rapid movement of the one or more permanent magnets 10 successively switches on and off the different electromagnets 20 in sequence to pull the one or more magnets 10 in a circular motion. This circular movement of the one or more magnets 10 generates an electric current in each central coil 40 to power the activating means 30 and to charge the battery 50 for storage or any excess electricity generated can be used to power other devices. Alternatively, as described in a second embodiment, the electromagnets 20 can be switched on when the same polarity of the one or more permanent magnets 10 pass to create a repulsive force which pushes the one or more permanent magnets 10 along the guide means 2 to propel the permanent magnets 10.

### RELATED APPLICATIONS

This application is a continuation in part application and claims priority to U.S. patent application Ser. No. 11/945,473 entitled “Circular Self-Powered Magnetic Generator” filed on Nov. 27, 2007 and PCT application serial number PCT/US08/83951 entitled “Circular Self-Powered Magnetic Generator” filed on Nov. 19, 2008.

### TECHNICAL FIELD

The present invention relates to an apparatus that generates electric currents through a plurality of coils to power or charge a battery using one or more moving permanent magnets and electro-magnetic coils. Power generation is self-sufficient i.e. no external power sources are needed.

### BACKGROUND OF THE INVENTION

The ability to generate an electric current by passing a magnet through a coil of electrically conductive wires is well known, and commonly referred to as the Michael Faraday experiment.

The use of wires wound around a rotating bank of magnets is a common practice in the manufacture of electric motors and electric power generators.

It has long been a goal to use naturally occurring mechanical power to generate electricity. Hydraulic generation of power uses water flows to turn turbines; wave's motion has been suggested to generate electricity; new wind driven propellers are now making electricity and solar energy can be captured and converted to electric energy by using solar panels.

All of these devices convert an external physical force or energy into electricity. The biggest problem with such devices is that the source of energy is not always constant. Water flows, wind and solar energy often times are not predictable and, in the case of solar power it is not available during the night.

It is therefore a desirable objective to develop electricity from a source that is relatively constant or at least predictable.

It is a further object to create a device that can generate electricity with very few losses in efficiency while having no adverse effects on the surrounding environment.

The following described invention uses a magnetic attraction of unlike poles or repulsion of like poles to create motion and converts the moving magnetic force field into electricity to generate a power supply.

### SUMMARY OF THE INVENTION

An improved power generation apparatus has one or more moving permanent magnets, each magnet having a north polarity at a first end and a south polarity at an opposite second end; a plurality of electromagnets are positioned in proximity to a guide means, the guide means preferably providing a low friction guide path in a continuous loop. The guide means can be in the form of guide rails and can be incorporated in structures like a hollow tubular annular or circular ring having an oval cross section for housing the one or more permanent magnets. Each electromagnet has a coil wrapped around a central iron core. When activated, at least one or more electromagnets provide either an attractive force of opposite polarity relative to an end or ends of the one or more permanent magnets or a repulsive force of the same polarity or a combination as the respective polarized ends of the permanent magnets move to generate a propulsive force to the one or more permanent magnets in one direction. The apparatus further has one or more activating means, preferably being in the form of a location sensing device and a switch combination for activating each electromagnet and a plurality of central coils encircling the one or more permanent magnets and the guide means and a battery or a series or bank of batteries connected to the ends of each of the central coils. Within each central coil a permanent magnet is moving rapidly along the guide means toward each closest electromagnet. In the preferred embodiment, as the N or S end of the permanent magnet approaches an electromagnet of the opposite polarity, the one or more activating means turns the closest electromagnetic coil on, creating an attractive electro-magnetic field pulling the moving permanent magnet in the direction of the field thus advancing the permanent magnet towards the electromagnet. The design of activating means can be a light and switch combination which functions such that the on state is very short, the rapid movement of the one or more permanent magnets successfully switches on and off the different electromagnets in sequence to pull the one or more permanent magnets in a circular motion. This circular movement of the one or more permanent magnets generates an electric current in each central coil to power the activating means and to charge the battery for storage or any excess electricity generated to be used to power other devices. Alternatively, as described in a second embodiment, the electromagnets can be switched on when the same polarity of the one or more permanent magnets pass to create a repulsive force which pushes the one or more permanent magnets along the guide means to propel the permanent magnets.

In a third embodiment the North polarity end of each of the one or more permanent magnets can be used to activate an electromagnet having an opposite South polarity causing an attractive pull on each of the permanent magnets, while the opposite South polarity end of each permanent magnet can activate an adjacent electromagnet of the same polarity to simultaneously create a repulsive pushing force, the combination of pushing and pulling forces providing a propulsion of the magnet in one direction around the guide means.

The power generation apparatus uses an activating means for activating each electromagnet. Preferably, the activating means is a light sensitive switch and a light source. The switch is activated or turned on by blockage by the permanent magnet or interruption of the light source. When the switch is activated the electromagnetic field of the corresponding electromagnet coil will be turned on. Preferably there is one switch or light source for activating all of the electromagnets and this switch may be activated by a single dedicated light source. In order to provide a way for the light to pass from the light source to the switch, a cutout slit, slot or opening or transparent material can be provided on a side of the guide path such that the light can pass from one side of the guide path to the switch on the opposite side of the guide path as the magnet is moving. Preferably the light source is a LED (in order to reduce power draw), laser or polarized light source or any defined wavelength of light. It may be desirable to isolate the switches from any ambient light or to have the switches respond to only polarized light or a predetermined wavelength. In one embodiment, each central coil has a large diameter encircling the guide path with small gaps to provide a space to allow support devices to hold the guide means in place without it impacting the central coil. These spaces are intended to be small which allows more turns of wire in each of the central coils; this has a direct impact on the amount of power generated. Each central coil is preferably made of one continuous conductive wire that is connected to and terminates at the battery or power source.

In order for the light source to transmit light to the switch, in an on/off action, they can be placed inside the central coils and made very small not to interfere with the ability to generate electricity or alternatively the switch and light source can be placed outside and between the central coils preferably attached to the support devices. In one embodiment the guide means is a tubular ring, the tubular ring will also be made to allow the light to pass being made of clear or transparent material. In this embodiment, the one or more permanent magnets should be slightly arcuately shaped so that it matches a small portion of the corresponding guide path of the ring such that both ends at the north and south poles are slightly curved having the same axial center as the ring. The permanent magnets preferably are shaped in cross section and curved longitudinally to precisely slide within the radius of curvature of a guide rail built into the ring. The tubular ring preferably has an elongated open or hollow cross section with bottom having a protruding guide rail to correspondingly accept a recess on the magnets or vice versa. These protrusions and recesses form the guide rails to locate each permanent magnet and allow them to glide along. Each permanent magnet either has or is connected to a guide structure with corresponding exterior surfaces, each guide structure has at least portions of a concave surface that fit against and partially over the inside circumferential surfaces of the protruding guide rails of the ring to locate and guide the one or more permanent magnets. Preferably the permanent magnet guide structure and the guide rails of the ring are coated or otherwise made to be of low friction surfaces such as Teflon or similar material. Alternatively, and especially when cylindrical permanent magnets are used, the tubular ring may form guide channels without rails.

In another embodiment, the entire ring portion of the system will be evacuated of any air; this helps reduce air resistance, friction and inertia dramatically, especially when the magnets are racing through at high speeds. Alternatively, this device can be used in space in the absence of gravity wherein the permanent magnet and all of the mechanisms are within a housing such that the movement can be created and repeated in such a zero gravity environment. The moving permanent magnets simply rely on the attractive or repulsive magnetic forces or combinations of both to provide movement and power generation. The objective is to use a minimal amount of electromagnetic force at each electromagnet requiring minimal use of electricity and that the activating means should be of minimal electricity consumption such that the power generated exceeds the amount of energy consumed in such a fashion that the battery can be charged or create excess electricity for other purposes. The invention expects that the amount of power generated far exceeds the power expenditure consumed by switches and electromagnets.

It is anticipated that the electricity generated in the central core will itself help re-magnetize the moving permanent magnet by the appropriate direction of the windings in central coil. This will eliminate the need to replace or re-magnetize the magnet at required intervals. This continuous process of re-magnetizing eliminates the interruption of the generation of electricity.

### BRIEF DESCRIPTION OF THE DRAWINGS

FIG. 1 is a perspective view showing an exemplary apparatus made according to the present invention.

FIG. 2 is a perspective exploded view of the exemplary apparatus of FIG. 1 with the top cover removed to show inside the lower housing of the apparatus.

FIG. 3 is a perspective view of the internally stored power generating apparatus with the outer housing portions removed taken from FIG. 1.

FIG. 4 is a perspective view of the apparatus showing the tubular ring assembly of FIG. 3 with the central coils removed.

FIG. 5A is an exploded view of the tubular ring assembly.

FIG. 5B is an exploded view of a tubular ring assembly according to an alternate embodiment of the present invention.

FIG. 6 is a top view of the exemplary apparatus of FIG. 1 with the top cover housing removed showing the assembly as mounted in the lower housing.

FIG. 7 is a partial view of the apparatus of FIG. 6 with the central core removed and with a motion detection means shown for detecting the moving permanent magnet.

FIG. 8 is a cross sectional view of the exemplary apparatus of FIG. 1.

FIG. 9 is a partial perspective lower view of the ring assembly showing the electromagnets supporting the tubular ring.

FIG. 10 is a partial perspective upper view showing a portion of the detection means.

FIG. 11 is an enlarged view of an electromagnet showing the bend of the top end of the core.

FIGS. 12A, 12B and 12C illustrate a magnet prior to entering a coil, as it enters a coil and as it leaves a coil, thus illustrating the effects of the magnetic field generated on the coil as the magnet traverses through the coil.

FIGS. 13A, 13B and 13C illustrate an alternative embodiment coil configuration where a coil wound in one direction is internally inserted in an external coil wound in an opposite direction.

FIG. 13A shows a magnet prior to entering the coil.

FIG. 13B shows the magnet as it enters the coil.

FIG. 13C shows the magnet as it leaves the coil, in this alternative embodiment the combination of two coils results in a nulling action on the magnetic field of the internal and external coils.

FIG. 14A illustrates a magnet entering a coil accelerator, this coil accelerator is a coil having a fewer layers at the entrance where the magnet enters and multiple windings of the coil at the exit, where the magnet leaves the coils. In this fashion the magnetic fields are stronger at the exit than they are at the entrance the resulting effect is shown in FIGS. 14B and 14C which creates an acceleration of the magnet toward the distal end of the coil and especially as it leaves the coil.

FIG. 14B the magnet is shown entering the coil having the fewest windings at the entrance and as shown in 14C the magnet is leaving the coil having multiple windings at the exit.

FIG. 15 is a partial plan view which shows the magnets moving internal of the device as they are entering coils. As shown, the sensor picks up the initial or leading portion of a magnet and the magnets are positioned such that the electromagnets are activated creating a south polarity pushing on the south end of the magnets; this causes a repulsive or pushing action driving the magnets around the internal mechanism of the device.

FIG. 16 is a partial plan view showing the magnets moving internal of the device wherein the sensor picks up the magnet prior to the location of an electromagnet 20 thus creating a pulling action on that magnet and simultaneously as the magnet continues past the electromagnets a pushing action is created as shown on the right hand magnet wherein the south pole of the electromagnet is pushing on the south pole of the magnet; this creates a pushing force added to a pulling force simultaneously. The electromagnets are set up so that as the magnet leaves the coil it is pulled from the exiting coil towards the electromagnet 20 on the left hand side of the view and on the right hand side of the view an electromagnet is positioned such that it pushes the magnet into the coil 40 as illustrated. This pushing and pulling action is an alternative embodiment to provide additional driving force for the mechanism.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures each use the same reference numeral for similar components. The structures employ basically the same components with variations in location or quantity thereby giving rise to the alternative constructions in which the inventive concept can be practiced.

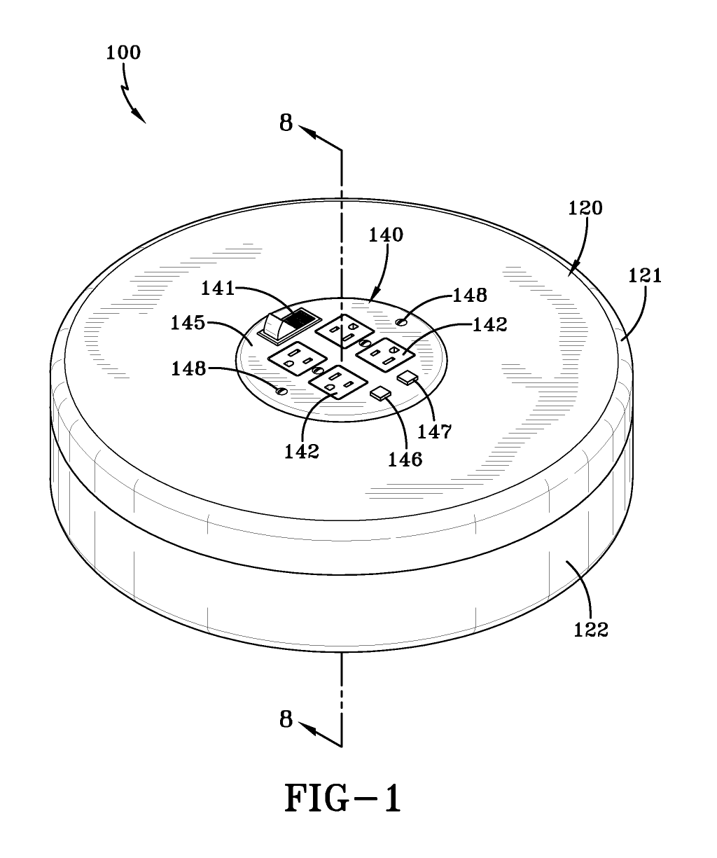

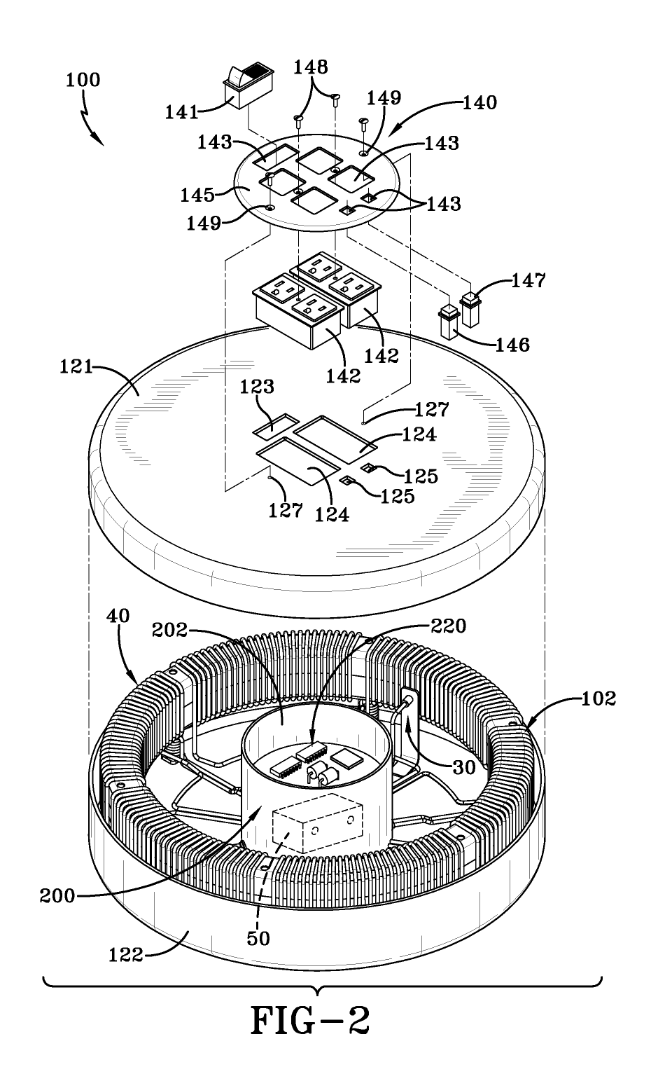

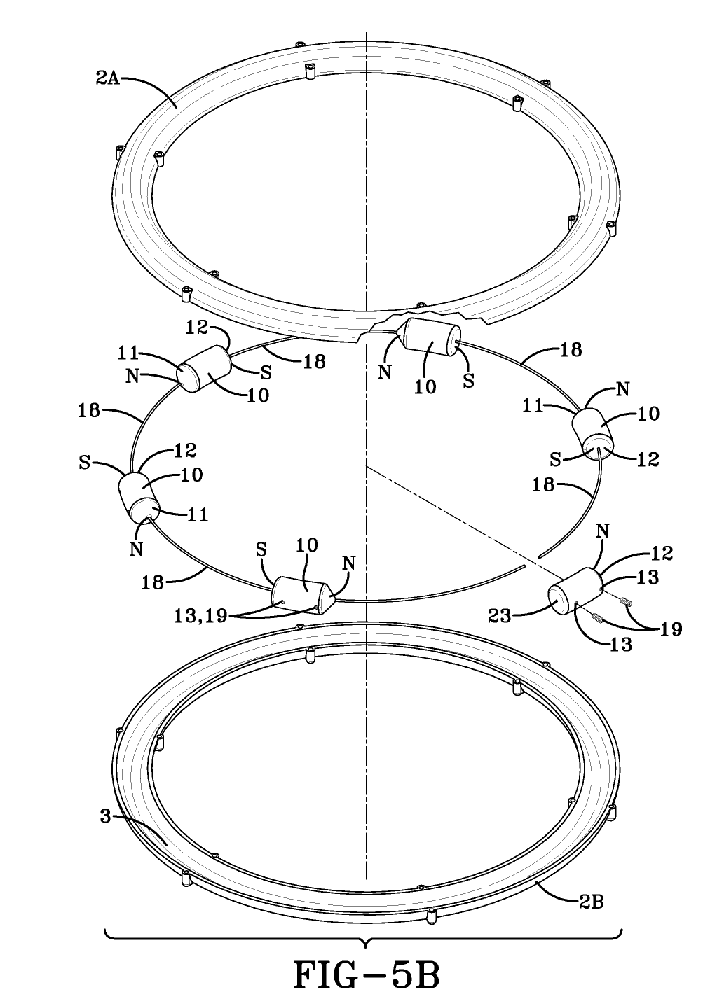

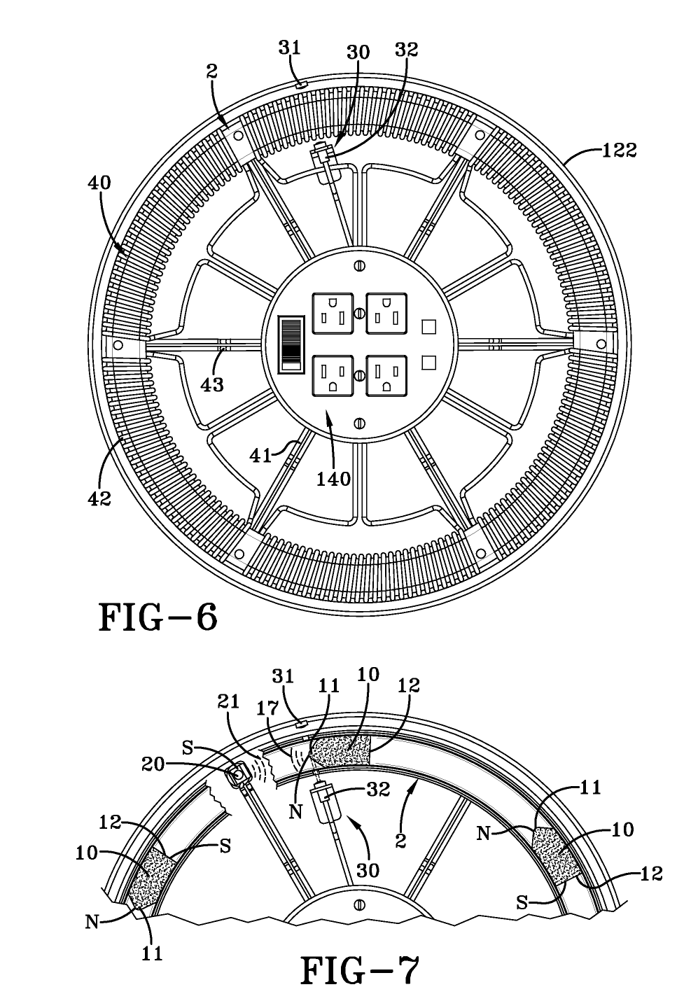

A circular self-powered magnetic generator apparatus 100 of an exemplary first embodiment of the invention is illustrated in FIGS. 1-5A, 6-10. As shown in FIG. 1, the circular generator apparatus 100 has an external housing 120 made of two pieces, an upper housing 121 and a lower housing 122. In the center of the upper housing 121 is a central control assembly 140. This assembly 140 shows an on/off switch 141, four plug outlets 142 and a pair of power indicator status lights 146, 147 which are covered by a circular cover plate 145 with fastener openings 149 as shown in FIG. 2. The cover plate 145 is held in place by a plurality of screws 148. The plate 145 has several openings 143 for the various components to pass through upon assembly. The entire apparatus 100 rests on a plurality of feet 66, the feet 66 preferably being made of an elastomer to dampen any vibrations as shown in FIG. 8.

As shown in FIG. 2, the generator apparatus 100 has the upper housing 121 removed from the lower housing 122 exposing the internally stored components.

The upper housing 121 has opening 123, 124 and 125 to allow the switch 141, the plug outlets 142 and the indicator lights 146, 147 to pass. The plug outlets 142 are attached to the plate 145 by fasteners 148 and the plate 145 is similarly attached to the upper housing 121 at threaded holes 127 by fasteners 148. The wires connecting the outlet plugs 142 are not illustrated or shown attached to a power source for clarity. The upper housing 121 and lower housing 122 have complimentary interlocking portions 64 that can be snapped together to complete the housing assembly 120 as shown in FIG. 8. These portions 64 allow easy access to the internal components of the apparatus 100 as shown in FIGS. 2 and 8.

When the power generator 100 is switched on, the apparatus 100 will start generating power which will be sent to one or more batteries 50 when the permanent magnet is moved to a position to block switch sensor means 30 to activate the electromagnet, which can be accomplished manually by tilting the assembly or preferably by using an external magnet. The batteries 50 will be charged electrically and once charged can be used to power electric appliances attached to the apparatus through the outlet plugs 142. The generator 100 will indicate a standby condition showing a light indicator 146 when lit and shows a charging condition when a light 147 is lit showing a green light when the apparatus 100 is ready for use, the indicator lights 146, 147 being red or green respectively to reflect a status. Once the status level reached a charged state a green light shows a sufficient amount of power is being created to operate externally attached appliances or equipment.

The above description is simply one of several examples of the uses for the apparatus 100 of the present invention.

As further shown in FIG. 2, the power generation is all created in the assembly of components stored in the lower housing 122. In the center of the device is shown a power supply assembly 200 including one or more batteries 50 (shown in dashed lines) stored in the cylindrical housing 202 and an electronic power conversion assembly 220 for converting direct current generated by the apparatus 100 to an alternating current (if desired). The power conversion assembly 220 includes a circuit board, rectifiers and other electronic components to achieve the desired power conversion as is well understood in the art. The power conversion assembly further includes a one-way current flow diode 221 or equivalent device which only allows the coils 40 to pass current into the power conversion assembly 220 and prevents current from the battery to back flow a current into the coils. In this way the coils only have a current generated as a magnet passes through the coil.

The power generation assembly 102 is used to create the power to charge the batteries 50 as shown in dashed or phantom lines. The annular power generation assembly 102 has a plurality of central coils 40 which capture moving magnetic fields 17 as shown in FIG. 7, and convert this power into an electric current which is fed back to the batteries 50 to charge them, as is discussed in greater detail as follows.

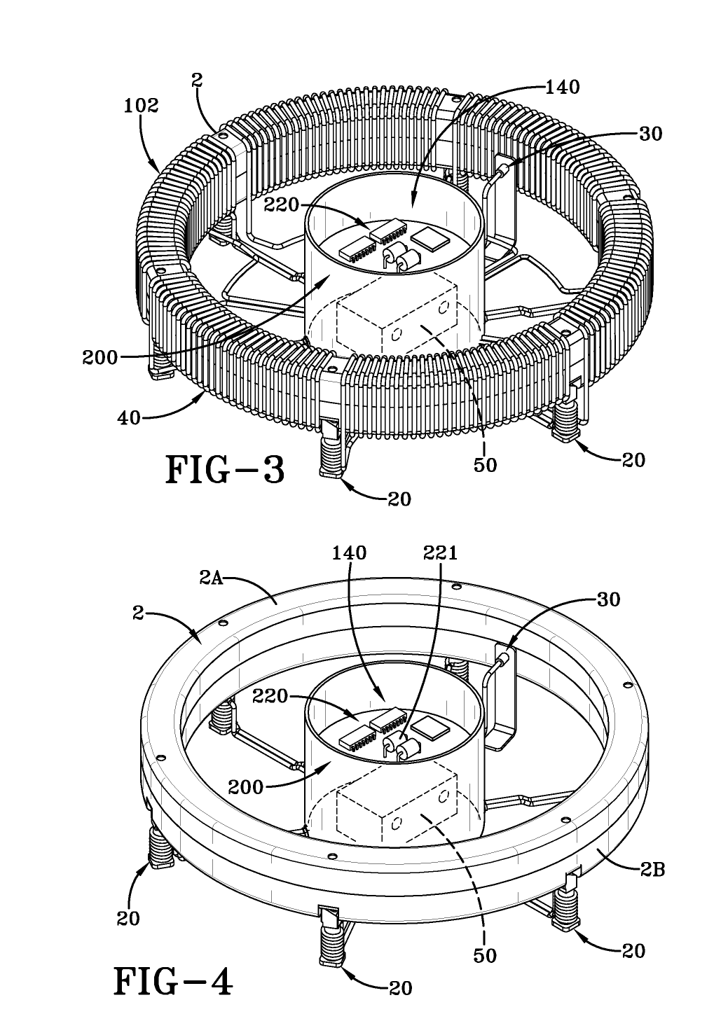

With reference to FIGS. 3, 4, 5A, 6 and 8, the exemplary power generating assembly 102 for the apparatus 100 is shown.

As shown in FIG. 3, the assembly 102 is connected to the power supply assembly 200 via each central coil 40. In FIG. 4, a ring 2 is shown supported on a plurality of electromagnets 20. Each electromagnet 20 is powered by and connected to a battery 50 in the central power supply assembly 200.

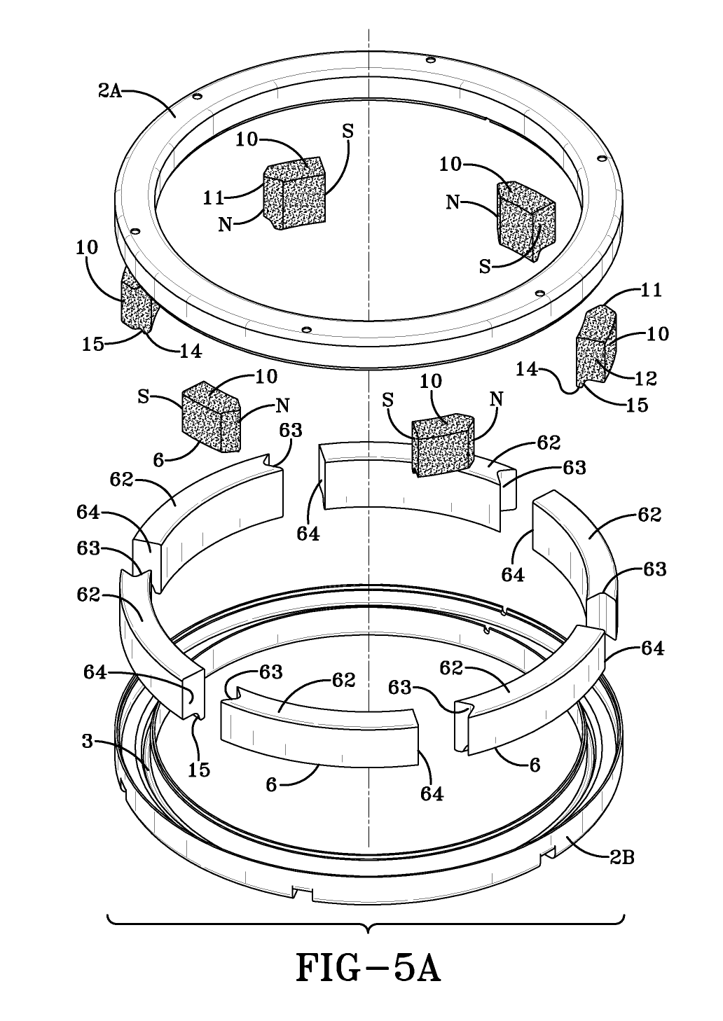

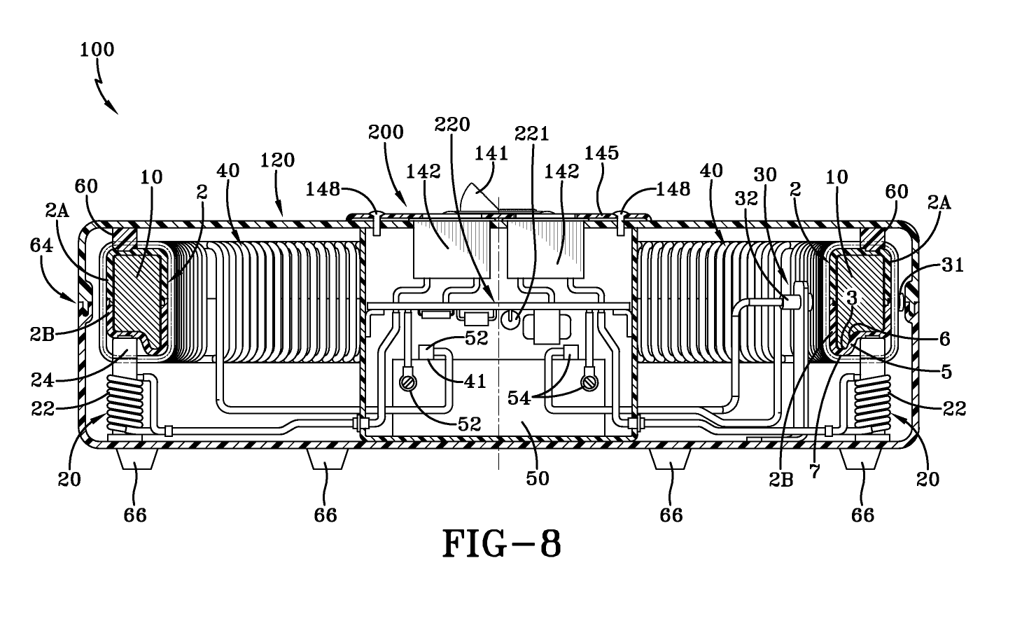

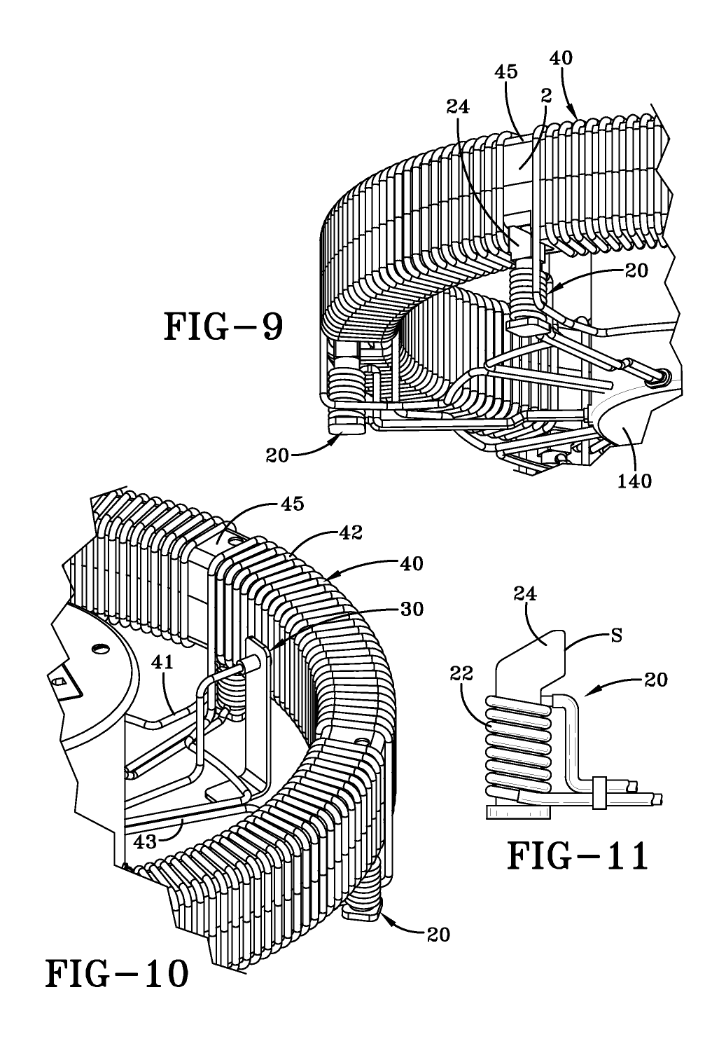

As shown in FIG. 5A and the cross sectional view in FIG. 8, one or more permanent magnets 10, preferably a plurality of permanent magnets 10 are positioned inside a hollow tubular annular or circular ring 2. The circular ring 2 is hollow preferably of a modified cross section having a unique design adapted to fit the one or more permanent magnets 10 in a fashion to locate and guide the magnets 10 within the hollow circular ring 2 with the least friction possible. Encircling the annular ring 2 is a plurality of central coils 40 as shown in FIGS. 2 and 3 connected in a parallel sequence, each central coil 40 being connected directly to a power source or one or more batteries 50, using conductive wire 42 which is wound about the ring 2 as shown in FIGS. 2, 3, 4 and 10 and connected at one end 41 to a positive terminal 52 of a battery 50 and thereafter encircles the annular ring 2 and continuing to a terminal end 43 connected to a negative post 54 of the battery 50. Between each central coil 40 there is provided a plurality of helical gaps at spaced locations 45 along the ring 2 as shown in FIGS. 9 and 10. At each spaced gap location 45 there is provided an electromagnet 20 which has an outer coil 22 and a central iron core 24 as shown in FIG. 11. The central iron core 24 preferably is adapted to fit against the annular ring 2 to provide support. Also shown are a plurality of supports 60 as shown in FIG. 8 on the upper housing 120 positioned around the ring 2 and extending opposite the electromagnets 20 which provide a secure positioning and locating of the annular ring 2 such as to hold the annular ring 2 firmly between the supports 60 and against the central iron core 24 of the electromagnets 20. These gap locations 45 can be the positions for one or more activating means 30, as shown in FIGS. 7, 15 and 16. Alternatively the activating means 30 can be simply directed between the wire 42 spacing in the central coils 40 as illustrated. Each switch 30 can be connected to the battery 50 and to a single electromagnet 20. Each switch 30 is light sensitive having a detector 31 on one side of the ring 2 and on the opposite side of the annular ring 2 is a light source 32 that is also connected to the battery 50 to complete a circuit. In the preferred embodiment as illustrated, one switch 30 is designed to activate all the electromagnets 20 simultaneously. In large generators 100 one switch may activate an electromagnet 20 with numerous central coils 40 spaced between electromagnets 20, not simply one coil 40 between pairs of electromagnets. This augments the power output by several fold, while reducing the power drain substantially.

With reference to FIG. 5B an exploded view of a second alternative embodiment of the device is shown wherein the device is housed in two annular rings of hemispherical cross sections such that when the rings are attached they form a circular cross section. The magnets 10 are shown having north and south polarities. At the north polarity the ends of the magnets are cone shaped while the south polarity has a flat or truncated end as illustrated. These magnets are designed to fit over a split wire ring 18 as illustrated this split ring 18 has the magnets moved to precise locations around the circumference of the wire 18 as illustrated. The magnets 10 are then secured in this position by fasteners 19 inserted through set screw fasteners 19 which are then threaded into holes 13 to fix the location of the magnets. Once placed on the split wire rings 18 and put through one end and positioned as indicated, the final magnet 10 is assembled wherein the ends of the wire 18 are inserted in the front and aft end of the magnet 10 and the set screws 13 are inserted locking the magnet 10 in place to form a continuous ring. Alternatively, the wire 18 can be a plurality of wires and each wire having an exact arcuate shape to position the magnets 10. In any event the principle is that the wires provide an equidistant spacing of the magnets 10 such that the magnets 10 can operate inside the cylindrical housing 2A and 2B and assembled as shown. There are no guide rails or other devices believed necessary as the device will hold its center fundamentally inside the tubular ring that is created. This creates a tubular housing 2A, 2B of almost a toroidal-shaped wheel upon which the coils can then be positioned around the device to create the final product. The advantage of using a fine wire as illustrated having an arcuate shape enables the mass to be greatly reduced, further the resistance created by the moving mass is fundamentally eliminated. The wire can be made out of carbon fiber, fine metal (like the music wire) bent properly to shape, or even glass tubes if so desired. This alternative device operates precisely the same was as the device in FIG. 5A although it is believed to be somewhat simpler in construction. As such the description that applies to the embodiment of FIG. 5A equally applies to this second alternative embodiment of FIG. 5B throughout the remainder of this disclosure.

With reference to FIG. 7, the central coils 40 have been removed exposing the annular ring 2 and showing one of the electromagnets 20 positioned on an underside of a portion of the annular ring 2. A top portion of the annular ring 2 is cut away to expose one of the one or more permanent magnets 10 which has a first end 11 and a second end 12. Preferably the first end 11 is a North pole and a second end 12 is a South pole. The magnet 10 is positioned in the annular ring 2 such that the first end 11 as it approaches an electromagnet 20 activates a switch 30 such that the electromagnet 20 is turned on for a short period of time. This electromagnet 20 generates an electromagnetic field 21 preferably creating an attractive force on the end 11 of each permanent magnet 10; this generates a pulling force on the magnet 10 and helps advance it inside the circular ring 2. Accordingly, an electromagnetic field 21 as shown in dashed lines is produced which has an opposite polarity relative to a magnetic field 17 emitting from the end 11 of magnet 10 as it approaches. Prior to each magnet 10 reaching one of the electromagnets 20, the electromagnetic field 21 remains switched off so as to avoid slowing the moving magnets 10. As the one or more magnets 10 inside the circular ring 2 further advances about the axis of rotation of the annular ring 2 another magnet 10 passes the switch 30 which will turn on the adjacent electromagnetic coil 22 creating an additional attractive force. This process is repeated continuously as the one or more magnets 10 move within the hollow ring 2. This continuous creation of electromagnetic force fields 21 having attractive forces with the end 11 of the magnet 10 creates a pulling effect and continuously accelerates the one or more magnets 10 until it or they reach a sustainable velocity. At this point the one or more magnets 10 are moving within the annular ring 2 in a very rapid fashion inside each central coil 40 and each of the moving magnets 10 creates an electric current in each of the central coils 40 and the current when connected to one or more batteries 50 then permits the batteries 50 to be continuously charged. This movement of the magnets 10 preferably generates more electricity than is used in activating electromagnets 20, the light sensitive switches 30 with the light 32 and detector 31 are used to activate the electromagnetic coils 22 producing fields 21. If the number of controls required to operate the system is considerably less than the number of coils 40 generating electricity, it is hoped that relatively more power is generated than is consumed. As a result, the apparatus 100 generates power to charge the batteries 50 and the excess power can be used to provide a power source for other devices if so desired.

In the above described apparatus 100 the use of a single magnet 10 moving inside the circular ring 2 dictated that one switch 30 is needed to activate each electromagnetic coil 20 as the magnet 10 moves along its circular guide path. It was determined that if the number of magnets 10 matched the number of electromagnets 20 and if each magnet 10 was precisely arcuately spaced equidistantly relative to each of the other magnets 10 then as one of the magnets 10 passed the one switch 30 at a single location, then each electromagnet 20 could be simultaneously activated by the single switch 30 to create several magnetic fields 20 simultaneously attracting each magnet 10 towards the nearest electromagnet 20 and also switched off simultaneously at a single switch 30. This preferred structure is shown in FIGS. 3, 4, 6, 7 15 and 16 and eliminates multiple switches required when using a single magnet 10. This assembly is best illustrated in FIGS. 7, 15 and 16.

With further reference to FIG. 8 a cross section is shown wherein the magnet 10 is shown directly above the electromagnet 20 and inside the hollow annular ring 2. The annular ring 2 has a unique hollow cross section. At the bottom of the annular ring 2, a protruding surface is formed such that the protruding surface forms an annular groove 3 in the bottom, as such the inside of the annular ring 2 is provided with the groove 3 to provide guide rails 5 for guiding and receiving the permanent magnet 10. Preferably, these guide rails 5 can be coated with a low friction surface 6 such that the magnet 10 can move very freely within the annular ring 2. The groove 3 being on one half of the bottom of the ring 2 provides a location on the other half of the bottom wherein an end 25 of the central core 24 of the electromagnets 20 can be positioned to support the ring 2. The groove 3 can also be used to help secure the ring 2 between the electromagnets and the supports 60. As shown, the annular ring 2 is preferably made of a partially or totally transparent material. The primary material for the annular ring 2 requires that it be very passive to electromagnetic fields 21 and magnetic fields 17 and this is important in that for the electromagnet fields 21 to move the magnet 10 these fields 21 must be free to pass through the ring 2 and to pull the magnet 10. Conversely, the magnets 10 must generate a magnetic field 17 as they move through each of the central coils 40 and that magnetic field 17 must be used to generate electricity within the coil 40. Therefore it is important that the ring 2 be adapted to permit the transfer of magnetic fields 21 across the thickness of the ring 2. Most preferably, as shown in FIG. 11, electromagnet 20 has the core 24 bent or oriented so that it can be facing toward the front end 11 of the permanent magnet 10 in substantially or almost straight-facing orientation to more powerfully direct the electromagnetic field 21 toward the field 17 of the permanent magnets 10. Plexiglass or clear plastics work exceptionally well for this purpose. As shown, the ring 2 can be sealed and evacuated so that there is no air internal to the ring 2; this further reduces some of the frictional drag. Similarly the ring 2 can be operated in a zero gravity environment such as outer space as a power propulsion or power generating system. In such a zero gravity condition the rails 5 within the ring 2 help guide the magnet 10 without requiring additional support.

With reference to FIG. 5A, a view is shown wherein the magnet 10 is shaped arcuately to match the diameter of the annular ring 2 therefore able to arcuately fit within a short portion of the ring 2 and smoothly pass. As shown, the magnets 10 have a cross section that has a protrusion 14 at bottom surfaces, this forms a rail 15 adapted to match the groove 3 side surface or guide rail 5 of the tubular ring 2. As such, when the magnet 10 is inserted inside the tubular ring 2, the magnet 10 will be located and positioned to freely slide within the tubular ring 2.

As shown, the magnet 10 can be coated with Teflon or other low friction material 18 to help facilitate its movement within the hollow ring 2. The inner lip of the rail 15 of the permanent magnets 10 may be truncated so as to reduce contact and thus aid ease of movement along the guide rails 5 of the ring 2. As shown, outer surfaces of the rail 15 of the magnet 10 are in contact with the rail 5 of the ring 2. The outer side surfaces of the magnet 10 can be gapped from the ring slightly by providing a clearance and as a result these surfaces never need to contact the annular ring 2 as the magnet 10 is moving rapidly within the ring 2 generating electric currents transmitted to and through the central coil 40 to the battery 50. As shown in the cross section of FIG. 8, the magnets 10 are shown to be snugly fitting in the hollow opening of the ring 2 nevertheless, adequate clearance must be provided to allow the magnets to move freely inside the ring 2. As shown in FIG. 5A, the ring 2 is preferably made in two annular pieces that can be snapped or glued together, an upper ring piece 2A and a lower ring piece 2B. This facilitates assembly of the magnets 10.

As further shown in FIG. 5A, the magnets 10 are preferably assembled with a connecting structure, as shown the connecting structure is a plurality of transparent arcuate pieces 62 having a flat end 64 and a “V” shaped end 63 to hold the flat end 12 and “V” shaped end 11 of the magnet. When assembled, the pieces 62 and 10 form a complete ring that can fit into the ring 2. This connecting structure can be adhesively glued to the magnets 10 or simply tightly fitted together. As shown, the connecting pieces 62 have a similar cross-section as the magnets 10 and provide portions of the guide rail 15 so when assembled, the guide rail 5 is a uniform ring of low friction surfaces to ride against the guide rail 5 of the annular ring 2. In order to reduce vibrations this assembled ring of connection structure and permanent magnets 10 is preferably balanced about its own axis of rotation. The connecting structure 61 can be any structure that rigidly fixes the spacing of the magnets 10 and can simply be a ring to which the magnets are affixed as opposed to separate pieces 62 if so desired, the purpose being to ensure a precise spacing and balance of the magnets as they propel inside the hollow ring 2. In any event the connecting pieces must allow the light from switches 30 to pass as well as the electromagnetic fields 21.

As shown in FIGS. 7, 10, 15 and 16, the timing of the switches 30 is critical to the activation of the electromagnetic fields 21. The switches 30 must be positioned in advance of the electromagnet 20 which is being activated when using attractive force propulsion. As the magnet 10 moves and comes into alignment with the light source 32 and the switch 30, the light is blocked and the switch 30 activates the electromagnet 20 while in advance of the approaching permanent magnet 10 as this electromagnet field 21 is only generated for a short duration of time. This pulse of electromagnetic field 21 creates a pulling effect on the magnet 10 and as such draws the magnet 10 rapidly towards the source of the field 21 as this advancing movement occurs the field 21 drops off and the magnet 10 moves to the next switch 30 which will then activate the next adjacent electromagnet 20 in advance of the approaching permanent magnet 10. Again the next electromagnetic field 21 is generated and this process is repeated continuously as the magnet 10 moves about this circular path within the annular ring 2. In principle the electromagnets 20 are simply positioned in such a fashion that a regular intermittent electromagnetic fields 21 are generated in advance of the approaching permanent magnet 10; nevertheless these electromagnetic fields 21 are only on for a short duration demanding very little amount of energy to be consumed from the battery 50. The light source is shielded preferably encased in an opaque chamber with narrow slit only a sliver of light impinges the switch detector 31 and this sliver of light is interrupted or otherwise blocked by the moving permanent magnet 10 which turns on the switch 30 to activate the electromagnet 20. At rest, the light sensitive switch 30 is in the off condition and the interruption of light turns on the switch 30. Preferably the movement of the magnet 10 is such that the amount of electricity generated in the coils 40 far exceeds the amount of electricity consumed in each revolution around the annular ring 2 as a result the battery 50 is constantly being charged and recharged in such a fashion that excess electrical energy being generated can be stored to provide power for other devices.

It is envisioned that this apparatus 100 can be used to power small appliances or other electrical equipment or simply to charge batteries. More aggressive applications include using several units in tandem for power generation capability to power electric motors to drive and propel vehicles potentially depending on the amount of energy that can be generated in the electric coil is simply a matter of the size of the cross section of the ring 2 and the diameter of the ring 2, size and power of the magnet 10, the number of central coils 40 and the amount of windings one can achieve around the central coil 40. As envisioned, each central coil 40 would provide a means for converting the magnetic energy of a moving magnetic force field inside the central coil 40 in such a fashion that a significant amount of electric current is generated during each revolution of the one or more magnets 10.

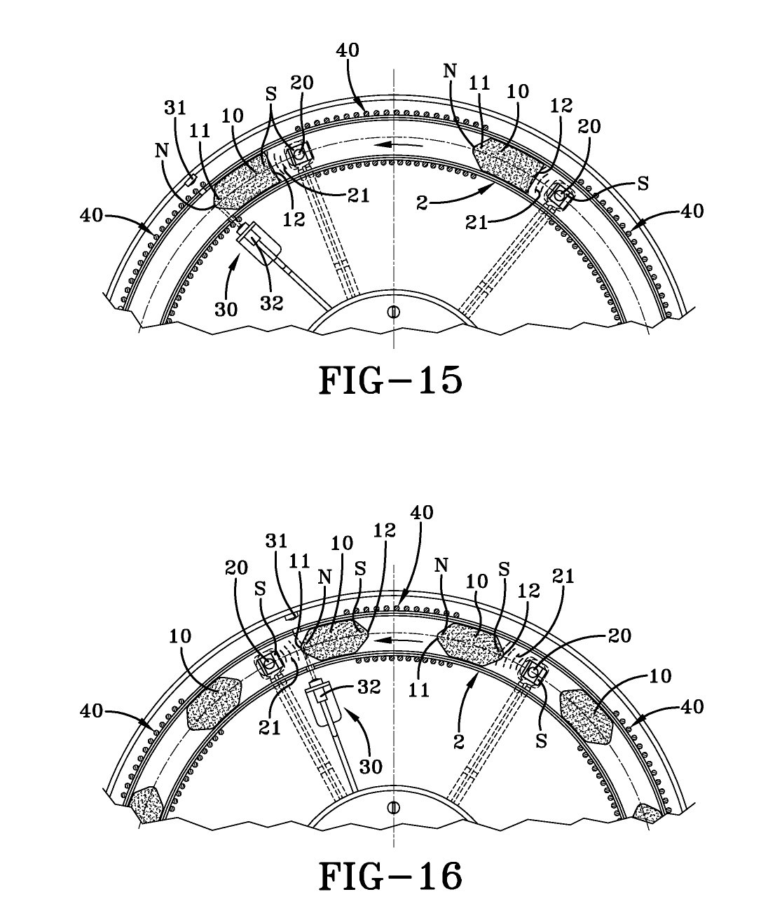

In an alternative embodiment as shown in FIG. 15, the electromagnet 20 instead of using opposite polarities as relative to the ends 11, 12 of the permanent magnet 10 moving can use the same polarity. In this embodiment, the one or more magnets 10 would move in an opposite direction wherein the end 11 would be pushed by repulsive forces causing a rotation in an opposite or counterclockwise direction around the axis of the annular ring 2. In such a case the winding of the central coil 40 may need to be wound in an opposite direction. It is important that the windings of the coil 40 are appropriate to create a constant recharging of the one or more magnets 10 accordingly as the magnets move in the opposite direction using the repulsive forces of the same polarities of the electromagnets 20, each magnet 10 is effectively pushed around the annular ring 2 as opposed to being pulled as was described in the preferred embodiment. In this embodiment the pushing action occurs basically in the same way with the concept that as each magnet 10 approaches, but in this case passes an electromagnet 20 with the aft end 12 of the magnet 10, the switch 30 is activated and the electromagnet 20 in close proximity to, but slightly behind that end 12 is activated such that magnet 10 is pushed rapidly away from the electromagnetic field 21. Again the electromagnetic field 21 is only generated for a short duration of time creating a pushing action on the one or more magnets 10 in a counterclockwise direction. As such again the magnet 10 will generate electricity and electromagnetic current will feed into the central coils 40 to charge a battery 50 in a similar fashion. It is believed that the attractive forces may be easier to generate as was described in the earlier preferred embodiment, however, it is equally possible to use repulsive forces to create a movement of the magnet 10 inside the hollow ring 2. Optionally as shown in FIG. 15, the electromagnets 20 can be moved such that they are positioned at the exit end of the coils 40 around the ring such that as the magnet passes and leaves one coil, the electromagnet 20 will fire when the magnet 10 triggers the photosensor or light 30 breaking the light firing the electromagnet to create a south polarity on the electromagnet that will push on the aft end of the magnet 10 which similarly has a south polarity. In this configuration the movement of the magnets 10 as shown is counter-clockwise and as the magnet 10 is entering into a coil as illustrated, the electromagnets are providing an additional push. This is advantageous as will be seen later with regard to electromagnetic resistance created by the magnets, movement through the coils 40.

As another additional alternative embodiment shown in FIG. 16 it is possible that a combination of electromagnets 20 can be used such that one electromagnet 20 can use attractive force in advance of the magnet 10 and second electromagnet 20 creates a repulsive force on the aft end of the one or more magnets 10 and to use both these fields to simultaneously create force fields 21 to create the push and pull combination as the magnet 10 advances through the annular ring 2. This is believed to be slightly more complex than the straightforward push or pull action; however the timing is such that it can easily be handled using a microprocessor. As such this combination is believed to be within the scope of the present invention as an alternative configuration which may be able to generate a more rapid movement of the magnet and thus generate even more power potentially. As further shown in FIG. 16, the electromagnets 20 are actually equally positioned between the adjacent coils 40 such that the electromagnets 20 can be fired to create a south polarity which pushes at one end of a magnet as it is entering the coil and actually attracts another magnet as it is exiting the coil. This is clearly illustrated in FIG. 16. This positioning enables both the attractive and the repulsive forces to be utilized in an advantageous manner described above, this creates the opportunity to pull the magnet 10 as it leaves through the coil 40 and to push a magnet 10 as it is entering into a coil 40. This again has an advantageous effect in reducing magnetic field losses that can be generated by the transfer of the magnet into the coil 40 as will be described hereafter.

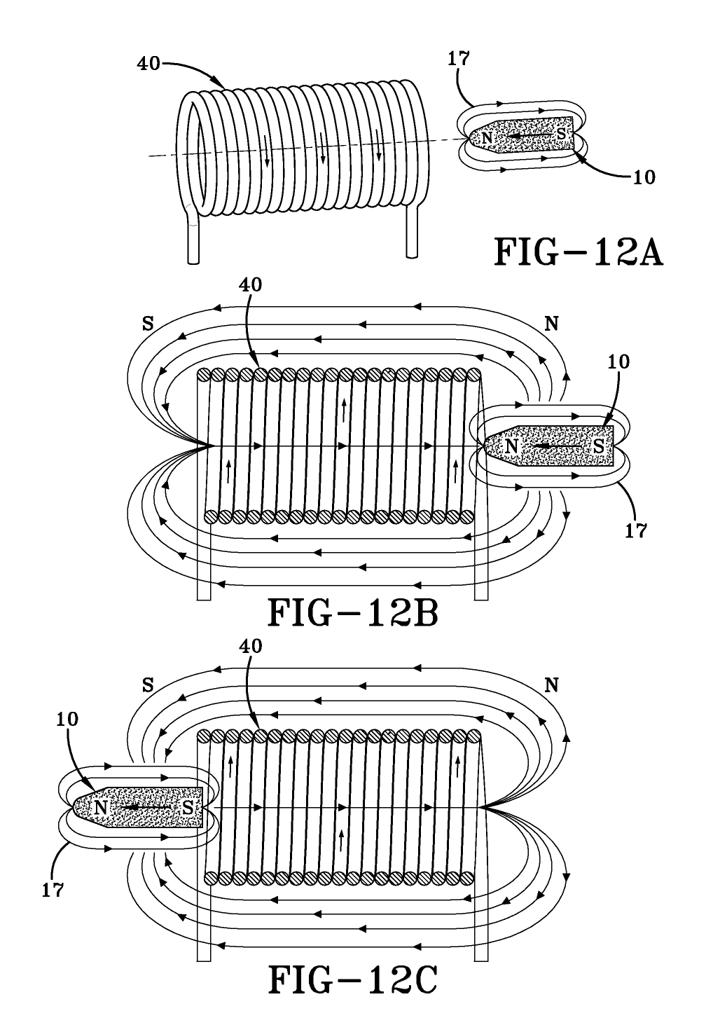

With reference to FIGS. 12A, 12B and 12C, as the magnet 10 moves toward a coil 40 as shown in FIG. 12A the magnet approaches the coil in such a fashion that there is no electric current generated within the coil 40. At the time at which the magnet 10 first enters the coil 40 as soon as the magnet 10 is in position as shown in FIG. 12B traversing into the coil, the magnetic field of the coil 40 is initiated as a result of the moving magnet 10 passing through the coil 40 creating an electric current. This electric current moving through the coil 40 itself creates a small magnetic field having a north end and a south end as shown when the coil 40 is wound in the direction of the arrows as illustrated. As shown in FIG. 12A the entire cylinder is shown and therefore the arrows are facing downward as they are being wound in a relative clockwise direction from the left side to the right side as illustrated. When cut in section as shown in FIG. 12B this means that you are looking at the inside of the coil 40 and the windings on that side are actually facing upward; however, the direction of coil winding is the same as illustrated in FIG. 12A. This results in a magnetic field being generated that is substantially uniform across the coil. The north magnetic field actually creates a slight inertial drag or a drag on the magnet 10 as it enters into the coil 40 because the north field of the coil is creating a repulsive action to the movement of the magnet 10 as the magnet 10 enters further into the coil 40 it is the north end of the magnet 10 is being pulled dramatically by the south polarity of the coil to assist in leaving the coil. This field of the coil 40 is also helping to push on the south end of the magnet inside the coil as it leaves. These are all beneficial, however the initial drag upon entrance creates a loss that can create a dampening effect on the movement of the entire magnetic ring as it passes inside its cylindrical housing ring. For purpose of this illustration, the housing ring 2 is eliminated to provide clarity and it is understood that these magnets 10 are actually moving within a housing that are also inside the magnetic coil 40, however, as you recall the housings are designed to allow magnetic fields to pass through clearly and freely being made of either a translucent plastic or other non magnetic material as illustrated. The point is that by eliminating these, the magnetic fields of the coils 40 more easily enable the magnets 10 to move. These coil field-induced losses as illustrated can be reduced or neutralized by clever designing of the coils as will be discussed below.

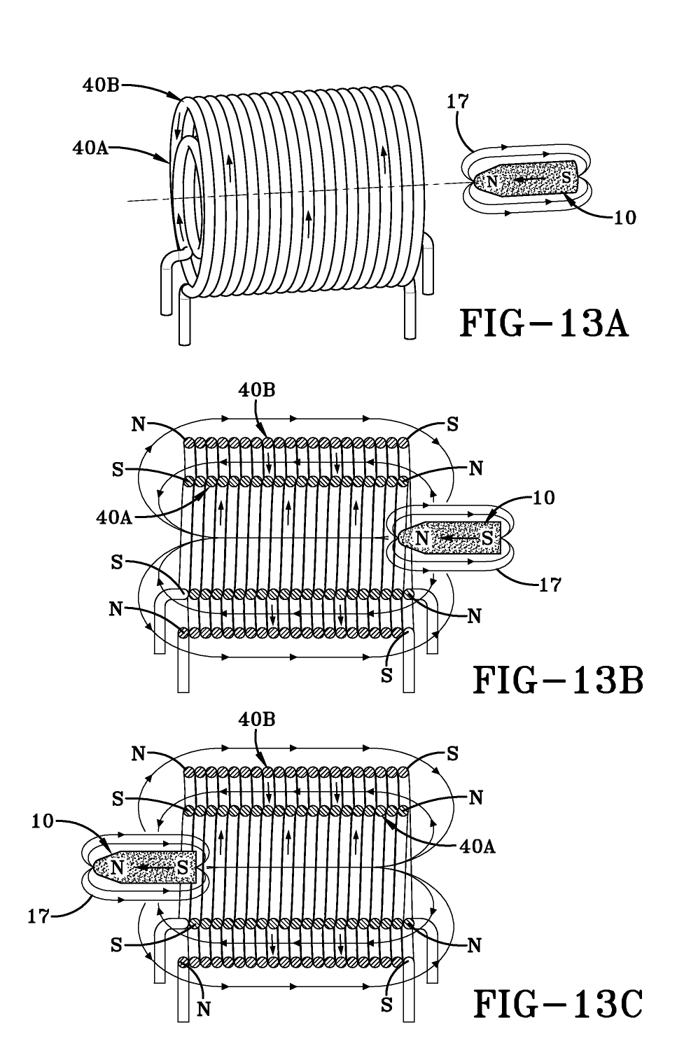

With regard to FIGS. 13A, 13B and 13C, a multiple coil arrangement is illustrated wherein as an alternative embodiment the device has a coil 40A internal of an external coil 40B. The device actually comprises two coils one coil 40A wound in a clockwise direction internal of an external coil 40B which is wound in a counterclockwise direction from left to right as illustrated. The external coil 40B entirely encircles the internal coil 40A. As a result, as the magnet 10 approaches the coil assembly 40A, 40B, the north magnetic field which creates a slight resistance is also somewhat nullified by a south facing field of the opposite coil. As a result, there is a lowering action of the electromagnetic fields created as the magnet 10 enters as shown in FIG. 13B or as it exits the coils 40A, 40B as shown in FIG. 13C. As a result there is a neutralizing effect on the magnetic coil field losses created by the movement of the magnet through the coils 40A and 40B. This is believed to be more efficient in that this type of winding will help assist in minimizing any magnetic field losses due to the movement of a magnet 10 through the coil.

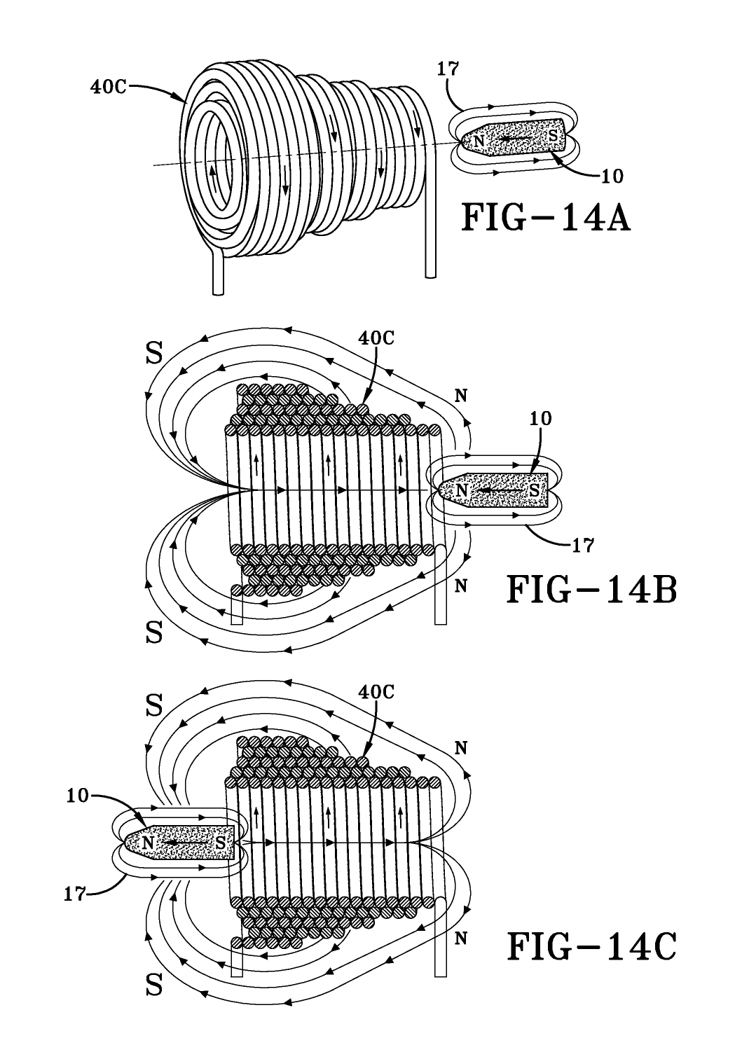

In yet another alternative embodiment, as illustrated in 14A, 14B and 14C, the coil 40C is illustrated which as shown has windings in a clockwise direction from the left hand side of the figures to the right hand side of the figures. In this embodiment however as the wires of the coils 40C are wound so they progressively narrow or are reduced to substantially fewer layers at the entrance where the magnet 10 will enter as shown in FIGS. 14A, 14B and 14C such that the magnetic field generated in 14B is substantially less than the magnetic field at the opposite south end of this coil 40C. The south end of the coil 40C has substantially more layers of winding and as a result, the magnetic field at the larger end of the coil is greater in size and magnitude. This accomplishes an accelerating effect that can be beneficially used as the magnet enters the coil 40C and leaves the coil. The initial repulsive force on the magnet 10 wherein the north pole is actually pushing against the north pole as shown in 14B is minimized by the use of less layers. As the magnet 10 enters into the coil 40C, the larger south pole field attractive forces on the north end of the magnet greatly assist in accelerating the magnet 10 through the coil 40C and as the magnet 10 accelerates once it penetrates the coil 40C it is then moving rapidly as it then exits the coil 40C. Upon exiting as shown, a large south repulsive force is created that by being somewhat larger helps create a stronger pushing action as the south pole of the magnet 10 is exiting.

In the manufacture of this device used for power generation it is believed that any one of these type of coils 40, 40A and 40B, or 40C can be used throughout the system. In other words the standard coil 40 as shown in FIG. 12A-C can be used exclusively in the system recognizing there will be some magnetic field losses or alternatively all the coils can be created as the alternatives shown in 13A-B wherein coils 40A are nested inside a coil 40B having opposite directional windings such that coils 40A and 40B create a nulling action wherein the magnetic field loss is reduced or the alternative accelerator coils 40C can be used wherein the magnets 10 movement can be accelerated through the coil 40C by having the windings excessively large on an exit end and smaller on an entrance end. Any of these combinations can be used together either in one or a plurality depending on the design preferred.

Ideally each of the apparatuses described above can be enclosed in the housing 120 structure to create a compact power generation unit. Each housing 120 can be equipped with power outlets to connect electrical charger devices or other appliances to power these pieces of equipment. Direct current or alternating current can be produced by the addition of known components to create the desired electrical outputs.

In a fourth embodiment of the present invention, the apparatus 100 as shown in FIGS. 3, 9, 10 and 11 is made very large and having numerous central coils 40. The guide means are constructed of either top and bottom guide rails 5 or a single guide rail 5 with the permanent magnets 10 mounted in a complimentary guide rail surface 15 adapted to slide freely along the guide rails 5 with a low or no friction contact, preferably the guide rail surfaces 15 and the guide rails 5 move around the guide path without contact similar to the first embodiment.

In principle this larger device operates as previously described, but with the capacity to produce large quantities of electricity for commercial purposes.

The apparatus can be made using only one permanent magnet 10 in combination with one electromagnet or multiple electromagnets, and one central coil 40 or multiple central coils 40, or one permanent magnet 10 with multiple electromagnets; or any suitable combination thereof. Furthermore, while one switch 30 is shown the apparatus may employ a plurality of switches 30 depending on the application. The annular ring 2 can be circular or alternatively oval in shape to form a loop as long as the magnets and connecting structures can be pivoted to adapt to straight and curved paths.

It is believed that super conductive coils designed to be used at room temperature can replace conventional materials to minimize energy losses as they become available.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A power generating apparatus comprises:
a guide means;
one or more moving permanent magnets each permanent magnet having a north polarity at a first end and a south polarity at the opposite second end located and guided along a guide path by the guide means;
a plurality of electromagnets, each having a coil and a central core, each electromagnet being positioned in proximity to the guide means and spaced about the circumference of the guide means, when activated each of the electromagnets provide an attractive force of the opposite polarity relative to the respective end of the nearest permanent magnet;
one or more activating means for each or several electromagnets;
a plurality of central coils encircling the guide means and the permanent magnet; and
a battery or a series of batteries connected to the plurality of central coils, and wherein the one or more permanent magnets are moved approaching toward each electromagnet and as the N or S end of the magnet approaches the electromagnets of an opposite polarity, the one or more switches turns on one electromagnet, creating an attractive electromagnetic field pulling the one or more permanent magnets in a forward direction towards the next adjacent electromagnet and switching the power off of the one electromagnet and thereafter switching the power on of the next adjacent electromagnet, creating another attractive magnetic field in a repeating action around the circumference of the guide means to pull the one or more magnets in a continuous forward direction, the movement of the one or more permanent magnets generating an electric current in the central coils to charge the battery.

2. The power generation apparatus of claim 1 wherein the activating means comprises:
one or more switches; and
a means for activating the one or more switches.

3. The power generation apparatus of claim 1 wherein the means for activating the one or more switches is a light source, each switch being activated by blockage of illumination from the light source and the switch being activated by interruption or blockage of the light source to send current to the coil of an electromagnet.

4. The power generation apparatus of claim 3 wherein the moving permanent magnet passes between and blocks the light emitted from the light source to the switch.

5. The power generation apparatus of claim 3 wherein the light source is an LED, laser, polarized light or any defined wavelength of light.

6. The power generation apparatus of claim 1 wherein each of the one or more permanent magnets is arcuately shaped having an axis of origin corresponding to the axis of the guide means.

7. The power generation apparatus of claim 1 wherein the plurality of central cores encircles most of the guide means.

8. The power generation apparatus of claim 7 wherein the plurality of central coils are spaced to form a plurality of gaps for supports to extend for holding the guide means.

9. The power generation apparatus of claim 6 wherein the one or more permanent magnets is arcuately shaped complimentary to a portion of the path of the guide means.

10. The power generation apparatus of claim 6 wherein the guide means includes a hollow tubular ring having a cross section of an elongated protrusion at bottom correspondingly forms a groove inside of the ring at bottom, the surface of protrusion forms a guide rail to guide and locate the one or more permanent magnets.

11. The power generation apparatus of claim 6 wherein each of the one or more permanent magnets has a cross-section with a protruding bottom surface, forming a guide rail to fit in the groove of the tubular ring.

12. The power generation apparatus of claim 6 wherein one or more ends of the one or more permanent magnets are aerodynamically rounded.

13. The power generation apparatus of claim 1 wherein the guide means has one or more guide rails, each guide rail forming a closed loop.

14. The power generating apparatus of claim 13 wherein the closed loop is oval or circular.

15. The power generating apparatus of claim 11 wherein each permanent magnet is fixed relative to other permanent magnets by a connecting structure.

16. The power generating apparatus of claim 15 wherein the number of permanent magnets is equal to or greater than the number of electromagnets.

17. The power generating apparatus of claim 15 wherein the number of permanent magnets is equal to or less than the number of electromagnets.

18. The power generating apparatus of claim 16 wherein each permanent magnet is spaced equidistantly on the connecting structure.

19. The power generating apparatus of claim 1 wherein the central coils further comprise one or more central coils having an internal coil and an encircling external coil, the internal coil being wound in an opposite direction than the external coil.

20. The power generating apparatus of claim 1 wherein the central coils further comprise one or more coil accelerators, each coil accelerator having more coil windings at one end relative to the opposite end.

21. A power generating apparatus comprises:
a guide means;
one or more moving permanent magnets each permanent magnet having a north polarity at a first end and a south polarity at the opposite second end located and guided along a guide path by the guide means;
a plurality of electromagnets, each having a coil and a central core, each electromagnet being positioned in proximity to the guide means and spaced about the circumference of the guide means, when activated each of the electromagnets provides a repulsive force of the same polarity relative to the respective end of the nearest permanent magnet;
one or more activating means for each or several electromagnets;
a plurality of central coils encircling the guide means and the permanent magnet; and
a battery or series of batteries connected to the plurality of central coils, and wherein the one or more permanent magnets are moved approaching toward each electromagnet and as the N or S end of the magnet approaches the electromagnets of a similar polarity, the one or more switches turns on one electromagnet, creating a repulsive electromagnetic field pushing the one or more permanent magnets in a forward direction towards the next adjacent electromagnet and switching the power off of the one electromagnet and thereafter switching the power on of the next adjacent electromagnet, creating another repulsive magnetic field in a repeating action around the circumference of the guide means to push the one or more magnets in a continuous forward direction, the movement of the one or more permanent magnets generating an electric current in the central coils to charge the battery.
